(19) United States
(12) Patent Application Publication
(10) Pub. No.: US 2004/0196780 A1
(43) Pub. Date: Oct. 7, 2004

(54) Multi-carrier code division multiple access communication system

(76) Inventors: Francois Po Shin Chin, Singapore (SG); Xiaoming Peng, Singapore (SG)

Correspondence Address: NATH & ASSOCIATES, 1030 15th STREET, 6TH FLOOR, WASHINGTON, DC, 20005, US

(21) Appl. No.: 10/392,081

(22) Filed: Mar. 20, 2003

(51) Int. Cl. H04J 11/00; H04B 1/707

(52) U.S. Cl. 370/208; 370/320; 370/335; 370/342; 370/441; 370/473; 375/146; 375/260

(57) ABSTRACT

A method for providing retransmission signals using multi-carrier code division multiple access is disclosed. The method comprises receiving a serial data stream in response to the failed prior reception of the serial data stream, and converting the serial data stream to a parallel data stream, the parallel data stream having a plurality of symbols having a symbol sequence. The method also comprises performing spreading on the parallel data stream by spreading each of the plurality of symbols of the parallel data stream with a spreading code, the spreading code having a plurality of chips having a chip sequence, and performing multi-carrier modulation on the parallel data stream by modulating each of the plurality of symbols of the parallel data stream to a plurality of subcarriers and generating a plurality of modulated signals. The method further comprises grouping the plurality of modulated signals for the plurality of symbols of the parallel data stream into a retransmission signal, and reordering, prior to the modulation of the parallel data stream, the parallel data stream by reordering at least one of the symbol sequence of the plurality of symbols and the chip sequence of the plurality of chips.

### FIELD OF INVENTION

The present invention relates generally to wireless communications systems. In particular, the invention relates to wireless packet transmissions in Multi-Carrier Code Division Multiple Access (MC-CDMA) systems.

### BACKGROUND

Wireless communications systems such as wireless Internet and mobile communications systems are receiving much attention. One reason for this is the number of wireless Internet services, such as services for downloading of large data files from web sites, is increasing. Therefore in wireless communications systems, High Speed Downlink Packet Access (HSDPA) is an important concept for achieving fast rates of data or packet transmission.

Direct Sequence Code Division Multiple Access (DS-CDMA) is a wireless access scheme that is suitable for supporting wireless communications systems because such a scheme facilitates packet transmission at high capacity or fast rates. Wideband Code Division Multiple Access (WCDMA), which is similar to DS-CDMA but for the bandwidth, is adopted in 3^{rd} generation (3G) mobile communications systems. In this scheme, the maximum data transmission rates supported in vehicular, pedestrian, and indoor environments are 144 kilobits per second (kbps), 384 kbps, and 2 megabits per second (Mbps), respectively. The HSDPA concept is discussed in a 3G Partnership Project (3GPP) based on the WCDMA air interface.

Data and packet transmission techniques or methods such as Adaptive Modulation and Coding (AMC), Hybrid Automatic Repeat reQuest (ARQ), and Multiple Input Multiple Output (MIMO) are expected to form essential technologies for achieving HSDPA. The objectives of the AMC, Hybrid ARQ, and MIMO techniques include increasing throughput, reducing delay and achieving packet transmission rates of up to 20 Mbps. Hybrid ARQ, in particular, by combining error detection and correction capabilities with retransmission of erroneous data, provides a reliable packet transmission method for packet transmission services.

However, simply introducing these packet transmission techniques into existing wireless access systems such as WCDMA systems operating with a 5-MHz bandwidth is not sufficient for achieving significantly higher packet transmission rates with a wide range of coverage. Therefore, a conventional wireless access scheme is proposed for broadband packet transmission together with Internet Protocol (IP)-based Radio Access Networks (RANs). This wireless access scheme can be based on multiple carriers such as Multi-Carrier CDMA (MC-CDMA) because MC-CDMA provides better performance than DS-CDMA for downlink communication in a highly selective channel with multiple resolvable paths. The ability to provide better performance stems from the capability of the MC-CDMA scheme to mitigate degradation of transmission quality due to severe Multi-Path Interference (MPI) in a broadband channel. MC-CDMA systems achieve this by using multiple low symbol rate sub-carriers, and make maximum use of frequency diversity by using spread and coded signals over parallel sub-carriers.

Single carrier wireless access schemes, such as those used in DS-CDMA systems, often suffer deep fading or degradation of transmission quality. Retransmissions in such systems predictably suffer deep fading as well when a channel is experiencing relatively slow fading. Therefore, when there are erroneous packets during transmissions, retransmissions are required and the retransmitted packets are combined together at a receiver to achieve combining gain to re-produce original packets in entirety.

It is possible that an erroneous packet cannot be recovered even when the maximum number of retransmission attempts is reached. Loss of erroneous packets poses a serious problem for packet transmission in DS-CDMA systems. On the other hand, MC-CDMA systems, which are based on a combination of CDMA and Orthogonal Frequency Division Multiplexing (OFDM) signaling, possess the advantages of both CDMA and OFDM. Since an MC-CDMA signal is composed of multiple narrow sub-carrier signals each of which has symbol duration much larger than any delay spread, MC-CDMA systems, unlike DS-CDMA systems, do not experience an increase in susceptibility to delay spreads and Inter-Symbol Interference (ISI). Moreover, an MC-CDMA signal can be easily transmitted and received using Fast Fourier Transform (FFT) without increasing transmitter and receiver complexity.

A conventional straightforward method for retransmitting packets for MC-CDMA systems involves a symbol being transmitted on the same sub-carrier during different retransmission attempts. At the receiver end, retransmitted packets with the same symbol are combined using packet combining to obtain combining gain. Since it is less likely that all sub-carriers in MC-CDMA systems are located in a deep fade in the frequency domain, the frequency diversity characteristic of MC-CDMA is not fully exploited in such a packet retransmission method.

A DS-CDMA system is a single carrier transmission system while MC-CDMA is a multiple carrier CDMA scheme based on a combination of CDMA and OFDM signaling. MC-CDMA schemes are mainly categorized into two groups, namely MC-CDMA and MC-DS-CDMA (OFDM-CDMA). MC-CDMA spreads the original data stream using a given spreading code and then modulates different sub-carriers with each chip in the spreading code, spreading packets in the frequency domain. MC-DS-CDMA or OFDM-CDMA spreads serial-to-parallel (S/P) converted data streams using a given spreading code, and then modulates a different sub-carrier with each data stream, spreading packets in the time domain similar to a normal DS-CDMA system.

In a DS-CDMA system, a packet combining process relating to the Hybrid ARQ method is typically applied for data transmission. When a received packet is detected to be erroneous, it is discarded or stored in a buffer and a Negative AcKnowledge (NAK) signal is sent to the transmitter requesting retransmission of the original packet.

There are three types of Hybrid ARQ methods, namely Type I, II and III Hybrid ARQ methods. The Type I Hybrid ARQ method involves straightforward packet combining in which an originally transmitted packet is retransmitted if the previous transmission of the originally transmitted packet is detected to be erroneous. The erroneous packet is either discarded or stored in a buffer.

There are two sub-types of Type I Hybrid ARQ methods, namely Basic Type I and Type I Chase Combining Hybrid ARQ methods, which are discussed in greater detail with reference to FIG. 1. FIG. 1 is a block diagram illustrating the Basic Type I and Type I Chase Combining Hybrid ARQ methods. The Basic Type I hybrid ARQ method is specified in the 3GPP specifications while the Type I Chase Combining Hybrid ARQ method is one of the schemes proposed for HSDPA systems.

A packet transmission sequence 100 according to the Basic Type I Hybrid ARQ method is described with reference to FIG. 1. In this sequence 100, Cyclic Redundancy Check (CRC) information is initially appended to the end of data 102 in a transmitter, which is then encoded into an encoded packet 104 using a Forward Error Correction (FEC) code and sent as a transmitted packet 106. The FEC code of a received packet 108 is decoded at a receiver and the quality of the received packet 108 is checked using the CRC information. If there are errors in the received packet 108, a retransmission of the transmitted packet 106 is requested. The erroneous received packet 108 is discarded and retransmissions of the same transmitted packet 106 occur until the data 102 is retrieved at the receiver.

A packet transmission sequence 101 according to the Type I Chase Combining Hybrid ARQ method is described with reference to FIG. 1 as an alternative way of transmitting the data 102, which is encoded into an encoded packet 112 and subsequently sent as a transmitted packet 114. When an initial received packet 116 is detected to be erroneous, it is stored in a buffer at the receiver and an NAK signal is sent from the receiver to the transmitter requesting retransmissions of the transmitted packet 114, resulting in subsequent received packets 118 being received by the receiver. At the receiver, the Chase Combining technique is used to combine the subsequent received packets 118 with the initial received packet 116 to generate accumulated received signal energies 120 for achieving diversity combining gain. The disadvantage, however, of the Type I Chase Combining Hybrid ARQ method is that additional memory is required to store the erroneous received packets.

In the Type II Hybrid ARQ method, also called Incremental Redundancy (IR) method, a packet transmitted in a retransmission is typically not identical with the packet transmitted in the original transmission. Only additional or incremental redundancy information is transmitted in the retransmission. The retransmitted packet has to be combined with the previously transmitted packet or packets before decoding is performed. The Type II Hybrid ARQ method allows code combining gain to be achieved.

In the Type III Hybrid ARQ method, also classified as IR Hybrid ARQ method, retransmitted packets contain additional or incremental redundancy information, but each retransmitted packet is self-decodable. The Type III Hybrid ARQ method is applicable in DS-CDMA systems that require more reliability.

In downlink data transmissions, a transmitted signal arrives at a mobile station as several time-delayed, amplitude-scaled rays of the transmitted signal along multiple paths in a wireless channel. If there is only one resolved ray, a frequency non-selective fading channel is observed. Data may be recovered at the mobile station using a simple despreader without any intra-cell interference. However, if there is more than one resolved ray, the wireless channel is called a frequency selective fading channel. A DS-CDMA receiver in the mobile station employs a Rake Combiner to coherently combine despread outputs from all resolved rays determined by a path searcher, thereby recovering the transmitted signal. In practice, the implementation of a receiver unit is more complicated if highly complex interference cancellation techniques are used.

A problem can occur in high data rate applications if channel delay spread exceeds symbol duration. When the channel delay spread exceeds the symbol duration, a DS-CDMA system is subjected to severe ISI and is practically not usable unless a complicated equalizer is used at the DS-CDMA receiver to combat the severe ISI. A technique for increasing the rate and also the symbol duration is therefore essential in this case. Multi-carrier modulation, for example in MC-CDMA, is proposed to advantageously reduce the effect of ISI by transmitting the same data symbol over a large number of narrowband orthogonal sub-carriers, without applying spectrum spreading to each carrier. With Turbo coding, one type of FEC coding, MC-CDMA achieves better performance. Each sub-carrier is subject to non-selective fading. With the reception of the same data symbol on different carriers, frequency diversity is also achieved.

The problem of ISI due to multiple paths become worse in high data rate applications because a complicated equalizer is required at the receiver to combat the ISI.

Another main advantage of MC-CDMA scheme is that the receiver can collect most of the received signal energy in the frequency domain. Conversely, another main disadvantage of DS-CDMA receiver is that such a scheme is not able to make full use of time-delayed signal energy received.

With reference to FIGS. 2a and 2b, a conventional MC-CDMA system applying a Straightforward Packet Combining (SPC) method is described. At an MC-CDMA downlink transmitter shown in FIG. 2a, a data stream 202 is first stored in a Tx buffer 204, which releases the data stream 202 depending on an ACK or NAK signal 206. The original data stream 202 is first processed by an FEC coding block 208, which uses codes such as convolutional code and Turbo code, and then by a modulation block 210. A stream of serial modulated symbols is converted to a parallel symbol stream with length N through a serial-to-parallel (S/P) converter 212. Each symbol is replicated into PG copies to form a parallel stream of the same symbol. For each symbol, each branch of the parallel stream is multiplied by each chip of a spreading code of length PG at a spreader 214 and then modulated to a sub-carrier spaced apart from neighbouring sub-carriers by Δf at a modulator 216. Through processing by a summer 218, a transmission signal 220 is produced which consists of the sum of the output of the branches of parallel streams of each symbol. Data in a total of N_{T}=N×PG parallel streams corresponding to the total number of sub-carriers is hence modulated in baseband in an MC-CDMA transmitter section 217 formed by the modulators 216 and summer 218, the operation of which can be modelled as an Inverse Fast Fourier Transformation (IFFT) operation. Up-conversion is then performed on the transmission signal 220 for transmission.

The structure of a conventional MC-CDMA downlink receiver is described with reference to FIG. 2b. After down-conversion and perfect synchronization, received data 232 is converted to parallel data by an S/P converter 234 and then each parallel component is demodulated with PG sub-carrier components at detectors 236 so that a received packet is first coherently detected. The S/P converter 234 and detectors 236 form an MC-CDMA receiver section 235 which performs a FFT operation. The transmitted information sequence is recovered by a despreading module using a spread code {g(0), g(1), . . . , g(PG−1)}, a bank of multipliers 238, Low-Pass Filters (LPF) 240, and a summer 242. Before FEC decoding, soft information from the current packet is combined using a Maximum Ratio Combining (MRC) module 244 with soft information from the previous packet stored in a buffer 246, the MRC module 244 preferably implementing Type I with Chase Combining hybrid ARQ method. An NAK signal 206 is generated for retransmission if the received packet is erroneous. Increased received energy after combining results in an improvement in throughput of the receiver. If the received packet is decoded correctly, an ACK signal 206 is sent back to the transmitter, and the next packet is transmitted. The erroneous packet is discarded absent the MRC module 244 and buffer 246 when Basic Type I hybrid ARQ method is used.

In MC-CDMA systems applying the SPC method, a symbol identical to a previous erroneous symbol is retransmitted using the same sub-carrier to which the previous erroneous symbol is modulated. If any one sub-carrier is subject to deep fading, then it is difficult to recover a symbol transmitted on that sub-carrier and therefore requires more retransmissions to recover an erroneous packet. Consequently, the throughput of an SPC-based MC-CDMA system is reduced. Moreover, erroneous packets make a system unreliable. Conversely, if frequency diversity can be properly applied, fewer retransmissions may be required to recover an erroneous packet in MC-CDMA systems.

Although an MC-CDMA system with Hybrid ARQ-based packet combining is an adequate proposal for broadband wireless packet access in downlink transmissions, there is clearly a need for a packet retransmission method for MC-CDMA systems for advantageously reducing the number of packet retransmissions for recovering erroneous packets.

### SUMMARY

In accordance with a first aspect of the invention, a method for providing retransmission signals using multi-carrier code division multiple access is provided, the method comprising the steps of:

receiving a serial data stream in response to the failed prior reception of the serial data stream;

converting the serial data stream to a parallel data stream, the parallel data stream having a plurality of symbols having a symbol sequence;

performing spreading on the parallel data stream by spreading each of the plurality of symbols of the parallel data stream with a spreading code, the spreading code having a plurality of chips having a chip sequence;

performing multi-carrier modulation on the parallel data stream by modulating each of the plurality of symbols of the parallel data stream to a plurality of subcarriers and generating a plurality of modulated signals;

grouping the plurality of modulated signals for the plurality of symbols of the parallel data stream into a retransmission signal; and

reordering, prior to the modulation of the parallel data stream, the parallel data stream by reordering at least one of the symbol sequence of the plurality of symbols and the chip sequence of the plurality of chips.

In accordance with a second aspect of the invention, a method for retrieving data subsequent to the failed prior reception of a transmission signal transmitted using multi-carrier code division multiple access is provided, the method comprising the steps of:

transmitting a failed reception signal in response to the failed prior reception of a transmission signal;

receiving a retransmission signal, the retransmission signal comprising a plurality of modulated signals for each of a plurality of symbols of a data stream in the retransmission signal, the data stream in the retransmission signal being reordered subsequent to the fail prior reception of the transmission signal;

retrieving the each of the plurality of symbols from the plurality of modulated signals;

reordering the data stream in the retransmission signal to the same order of a data stream in the transmission signal; and

performing packet combining of the reordered data stream in the retransmission signal.

In accordance with a third aspect of the invention, a system for providing retransmission signals using multi-carrier code division multiple access is provided, the system comprising:

means for receiving a serial data stream in response to the failed prior reception of the serial data stream;

means for converting the serial data stream to a parallel data stream, the parallel data stream having a plurality of symbols having a symbol sequence;

means for performing spreading on the parallel data stream by spreading each of the plurality of symbols of the parallel data stream with a spreading code, the spreading code having a plurality of chips having a chip sequence;

means for performing multi-carrier modulation on the parallel data stream by modulating each of the plurality of symbols of the parallel data stream to a plurality of subcarriers and generating a plurality of modulated signals;

means for grouping the plurality of modulated signals for the plurality of symbols of the parallel data stream into a retransmission signal; and

means for reordering, prior to the modulation of the parallel data stream, the parallel data stream by reordering at least one of the symbol sequence of the plurality of symbols and the chip sequence of the plurality of chips.

In accordance with a fourth aspect of the invention, a system for retrieving data subsequent to the failed prior reception of a transmission signal transmitted using multi-carrier code division multiple access is provided, the system comprising:

means for transmitting a failed reception signal in response to the failed prior reception of a transmission signal;

means for receiving a retransmission signal, the retransmission signal comprising a plurality of modulated signals for each of a plurality of symbols of a data stream in the retransmission signal, the data stream in the retransmission signal being reordered subsequent to the fail prior reception of the transmission signal;

means for retrieving the each of the plurality of symbols from the plurality of modulated signals;

means for reordering the data stream in the retransmission signal to the same order of a data stream in the transmission signal; and

means for performing packet combining of the reordered data stream in the retransmission signal.

### BRIEF DESCRIPTION OF DRAWINGS

Embodiments of the invention are described hereinafter with reference to the drawings, in which:

FIGS. 1a and 1b are block diagrams of hybrid ARQ Basic Type I and Type I Chase Combining schemes, respectively;

FIGS. 2a and 2b are block diagrams of a conventional MC-CDMA downlink transmission system including a transmitter and a receiver, respectively;

FIG. 3 is a frequency response diagram of a wireless channel in the time domain and the frequency domain;

FIGS. 4a and 4b are block diagrams of a MC-CDMA downlink transmission system including a transmitter and a receiver, respectively, using a Symbol-Level Interleave method according to a first embodiment of the invention, respectively;

FIGS. 4c and 4d are block diagrams of a MC-CDMA downlink transmission system including a transmitter and a receiver, respectively, using a Chip-Level Interleave method according to a second embodiment of the invention, respectively;

FIGS. 5a and 5b are block diagrams for illustrating packet retransmissions in the MC-CDMA systems of FIGS. 2a and 2b and 4a and 4b, respectively;

FIGS. 5c and 5d are block diagrams for illustrating variations of the packet retransmission method in the MC-CDMA system of FIGS. 4c and 4d; and

FIGS. 6 to 9 are chart diagrams for illustrating the performance of the MC-CDMA systems of FIGS. 4a and 4b and 5a and 5b.

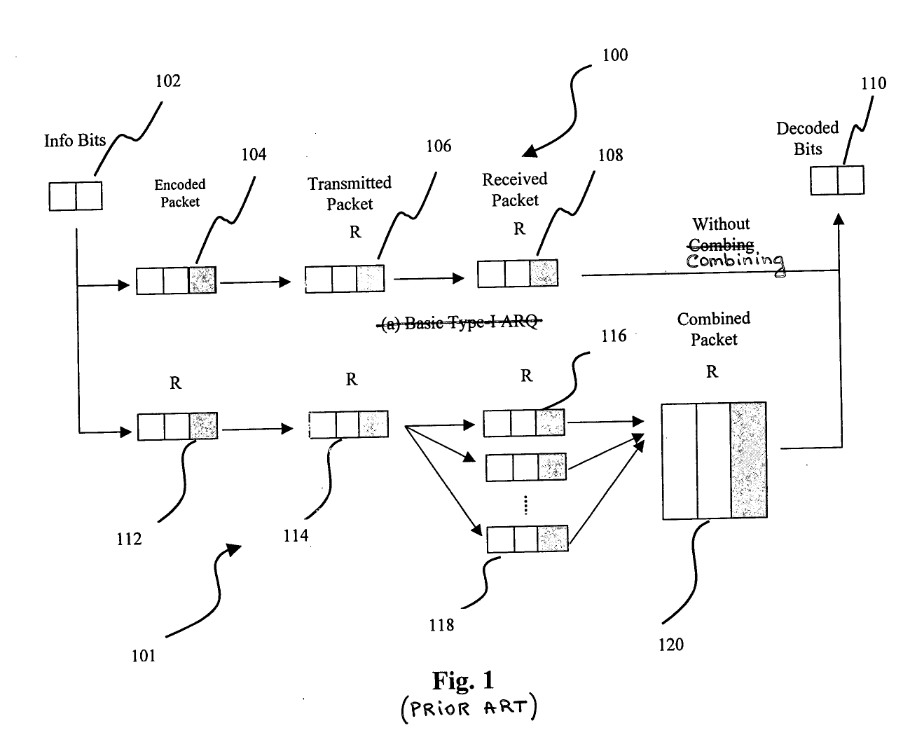

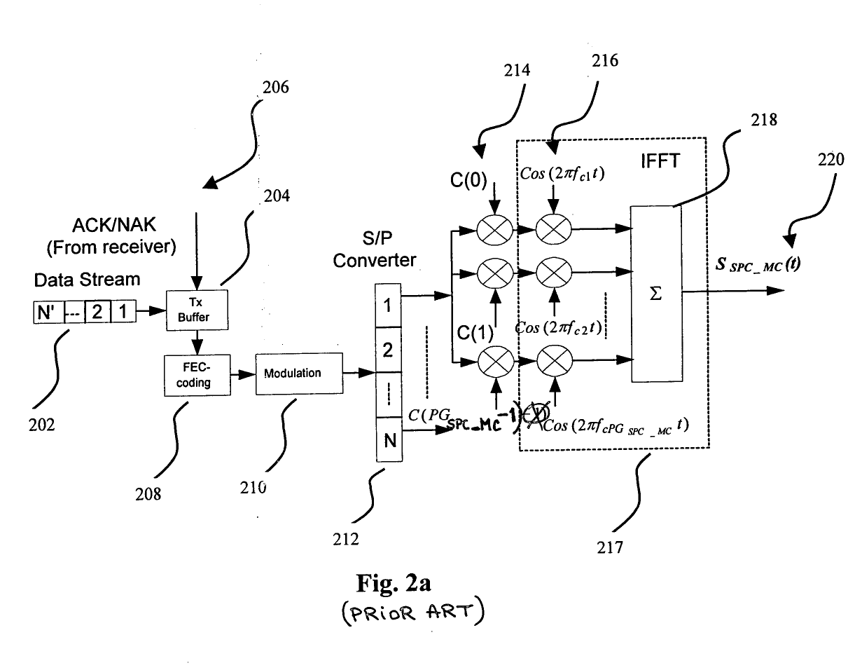

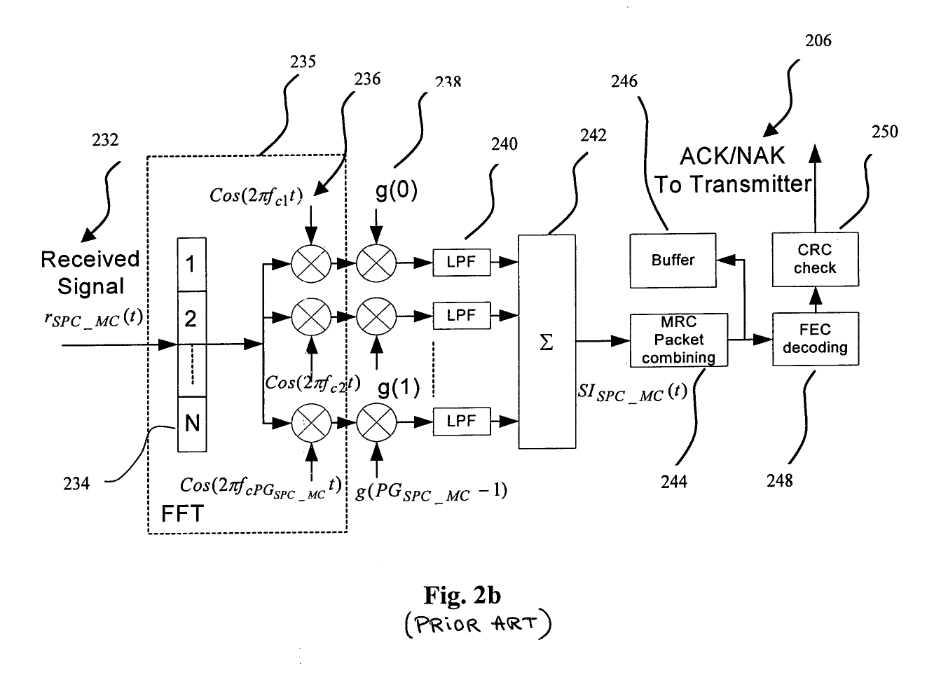

### DETAILED DESCRIPTION

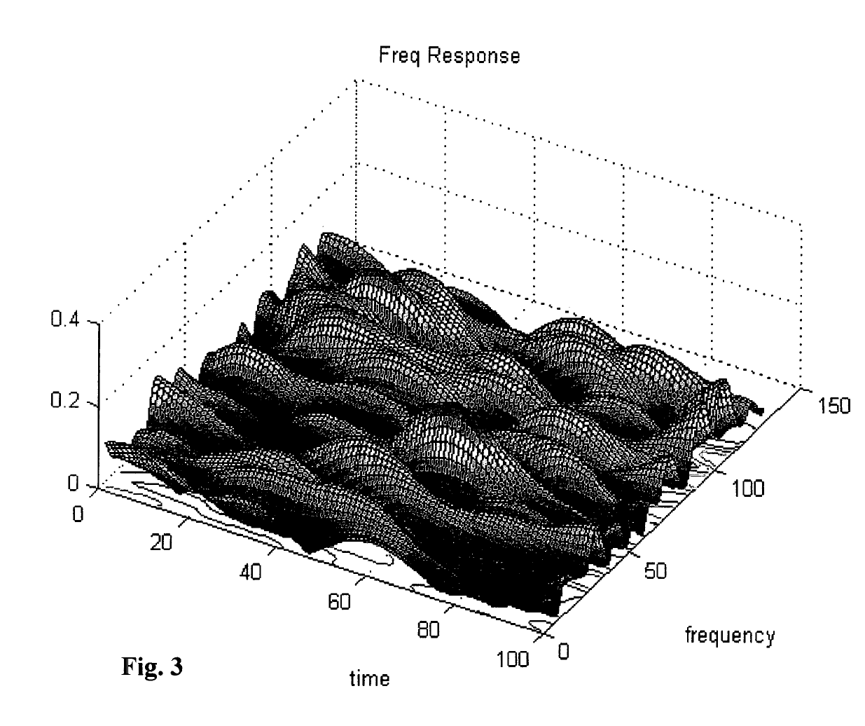

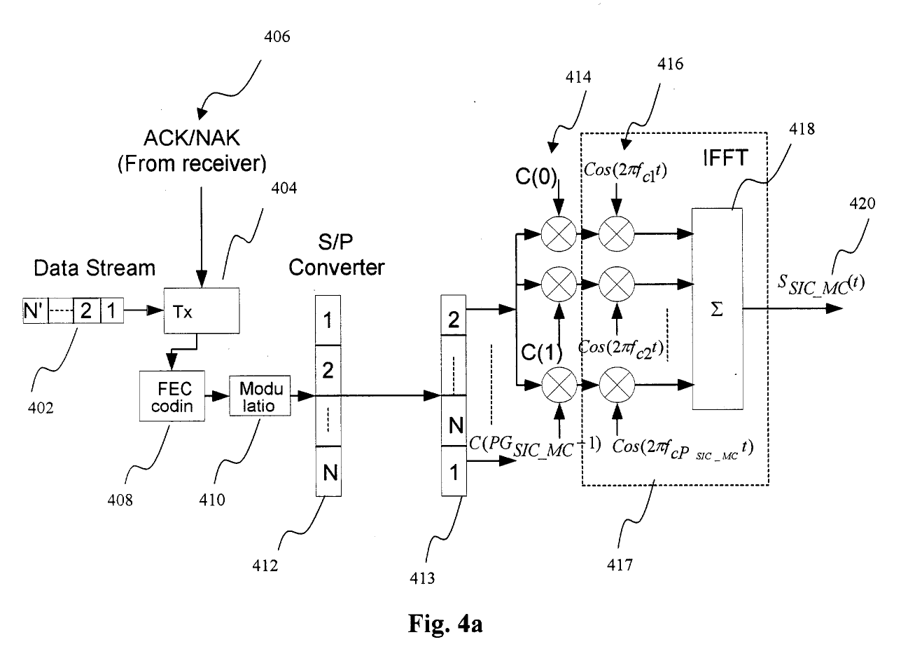

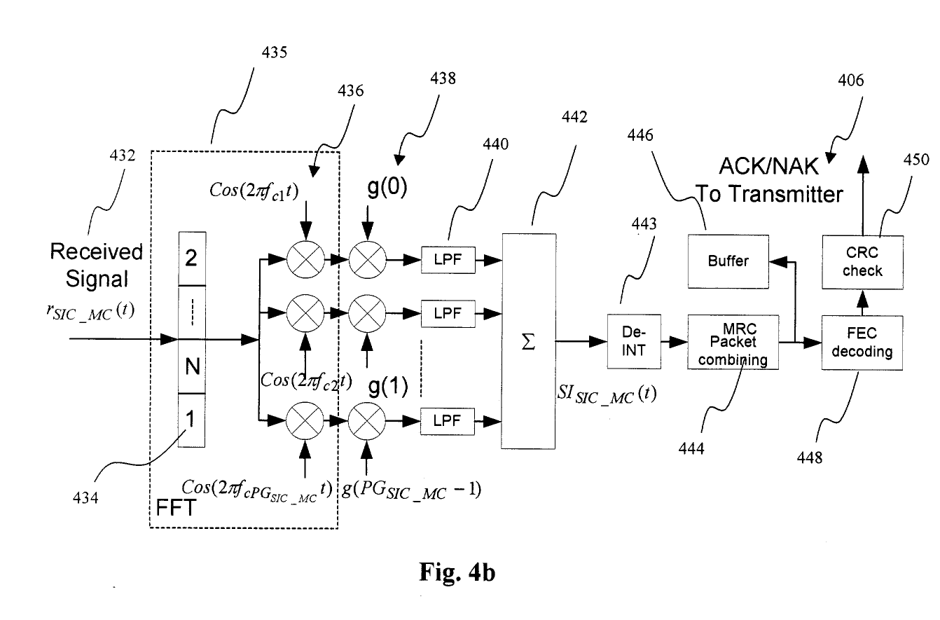

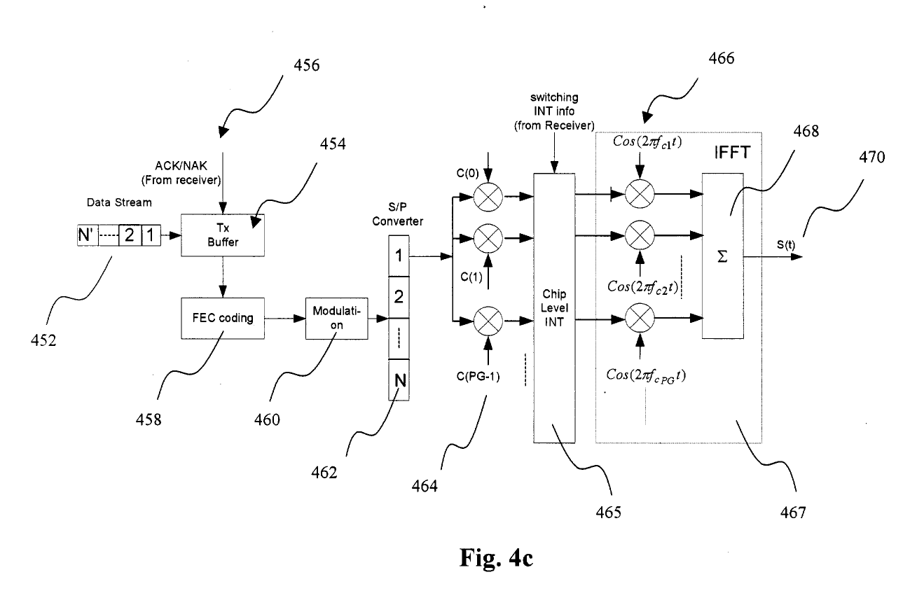

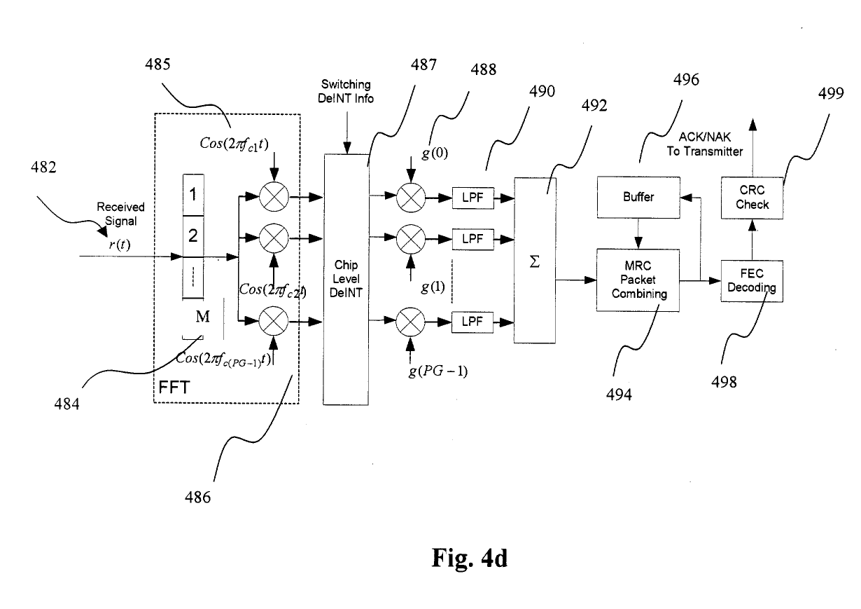

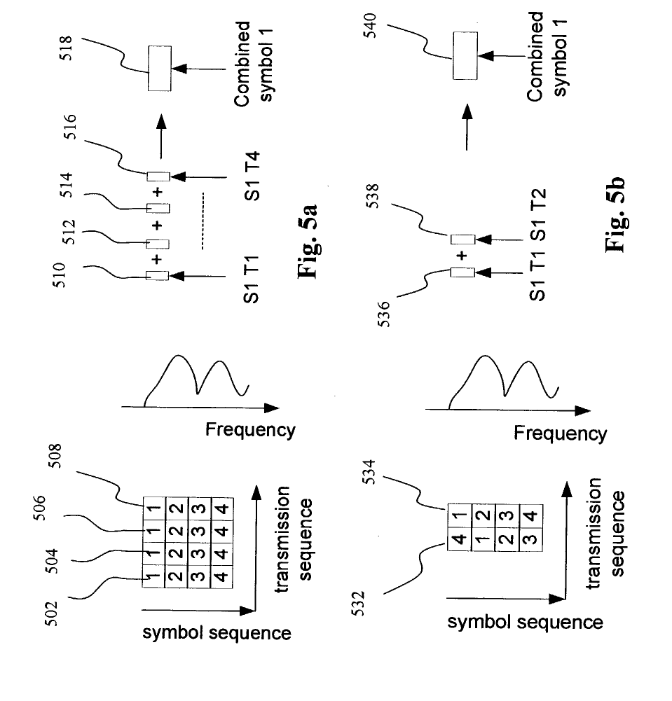

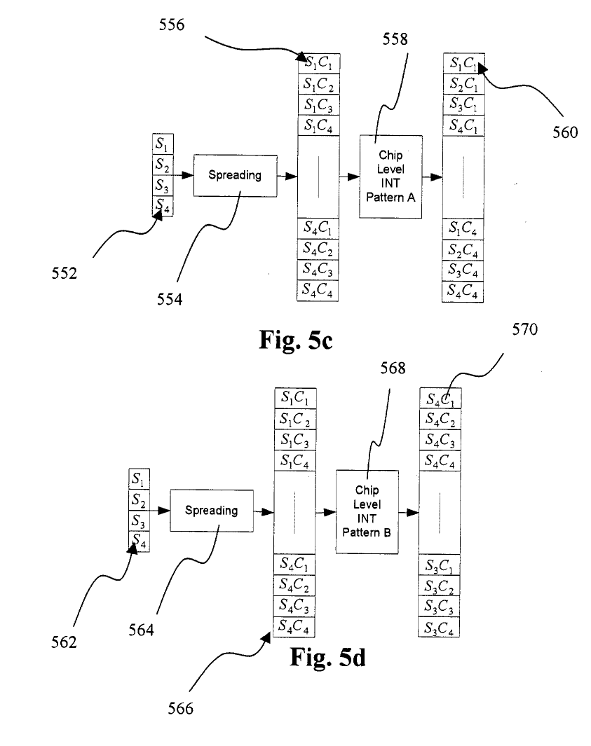

Embodiments of the invention are described hereinafter with reference to FIGS. 3 to 9 for addressing the need for a packet retransmission method for MC-CDMA systems for advantageously reducing the number of packet retransmissions for recovering erroneous packets. A packet retransmission method known as an interleave method for MC-CDMA systems is described hereinafter. More specifically, various implementations of the interleave method including a Symbol-Level Interleave (SLI) method and a Chip-Level Interleave (CLI) method are described with reference to FIGS. 4 and 5.

The interleave method provides a way to improve the throughput of an MC-CDMA system by advantageously applying frequency diversity. The interleave method is simple to implement and is easily extendable to any Multi-Carrier Modulation (MCM) technique, which is feasibly a key technique for high-speed mobile communications.

Descriptions provided hereinafter are based on downlink transmissions in MC-CDMA systems. However, the interleave method can also be used in uplink transmissions as well.

Although only Type I Hybrid ARQ is considered in the interleave method described hereinafter, other hybrid ARQ methods can also be used.

The frequency response of a channel in the time domain and the frequency domain is shown in FIG. 3. The channel is modelled as a Wide-Sense Stationary Uncorrelated Scattering (WSSUS) channel with L received paths using a complex equivalent low-pass time variant impulse response:

$$h ( τ ; t ) = {\sum }_{l}^{L} {g}_{l} ( t ) δ ( τ - {τ}_{l} ) \qquad ( 1 )$$

where t and τ are the time and the delay, respectively, δ(.) is the Dirac delta function, gₗ(t) is the l^{th} path gain which is a mutually independent complex Gaussian random process with zero mean and variance σₗ² for different l paths, and πₗ is the propagation delay for the l-th path.

If the original symbol rate of a data stream is high enough for the transmission of the data stream to become subject to frequency selective fading, the data stream needs to first undergo serial-to-parallel (S/P) conversion before being spread over the frequency domain.

FIGS. 4a and 4b are block diagrams of a downlink transmitter and a downlink receiver, respectively, applying the SLI method in an MC-CDMA system according to a first embodiment of the invention. In the MC-CDMA transmitter shown in FIG. 4a, a high rate serial data stream 402 is first input to a Tx buffer 404, which is dependent on an ACK or NAK signal 406, and then processed by an FEC coding block 408 and a modulation block 410. Subsequently, the modulated serial data stream is provided to a serial-to-parallel (S/P) converter 412 to obtain a parallel data streamD (d₀(i), d₁(i), . . . , d_{N-1}(i)). The output of the S/P converter 412 is processed by an interleaver (INT) 413 which reorders the symbol sequence of the parallel data stream. Preferably, the interleaver 413 performs rotation or shifting or the like reordering operation on the symbol sequence in the parallel data stream.

For the first transmission of each packet, the symbol sequence of the interleaved parallel data stream is the same as the output of the S/P converter 412. For each subsequent different retransmission until the maximum number of retransmissions, however, the symbol sequence of the interleaved parallel data stream is different. Each symbol of the interleaved parallel data stream is then replicated and multiplied with each chip of a spreading code with length PG at a spreader 414. The number of sub-carriers modulated at a modulator 416 with each symbol of the interleaved parallel data stream 413 is also set to PG. The sum of the outputs of N×PG modulated sub-carriers at a summer 418 results in a transmitted signal 420. This process yields a multi-carrier signal with the sub-carriers conveying an N coded data stream. The modulators 416 and summer 418 collectively form an MC-CDMA transmitter section 417 which can be modeled to perform an IFFT operation.

In a downlink channel, Walsh Hadamard codes are used as optimum orthogonal sets, and the complex equivalent low-pass transmitted signal is written as:

$$S ( t ) = {\sum }_{i = - ∞}^{+ ∞} {\sum }_{n = 0}^{N - 1} {\sum }_{m = 0}^{PG - 1} {d}_{n} ic ( {mp}_{s} ( t - {iT}_{s} ) cos \{ 2 π ( Nn + m ) Δ f ( t - {iT}_{s} ) \} \qquad ( 2 )$$

where c(m) is the spreading code with length PG, Tₛ is the symbol duration at sub-carrier, Δf is the minimum sub-carrier separation, and pₛ(t) is the pulse waveform defined as:

$${p}_{s} ( t ) = \{ \begin{matrix}1 & ( 0 \leq t \leq {T}_{s} ) \\ 0 & ( otherwise )\end{matrix} \qquad ( 3 )$$

In the MC-CDMA receiver shown in FIG. 4b, a received signal 432 is first combined in the frequency domain. The receiver can therefore always use the energy of all the received signal scattered in the frequency domain, which is the main advantage of MC-CDMA schemes over other schemes. The received signal 432 then undergoes serial-to-parallel conversion in an S/P converter 434 to form a parallel data stream, of which each parallel component is then detected by PG parallel detectors 436 using PG sub-carriers, each detector 436 for detecting a replica of each data symbol of the parallel data stream using a corresponding sub-carrier. The S/P converter 434 and detectors 436 collectively form an MC-CDMA receiver section 435 to perform coherent detection of the received signal 432, the operation of which can be modeled as an FFT operation. The received signal 432 is written as:

$$\begin{matrix}r ( t ) = {\int }_{- ∞}^{+ ∞} S ( t - τ ) ⊗ h ( τ ; t ) ⅆ τ + n ( t ) \\ = {\sum }_{i = - ∞}^{+ ∞} {\sum }_{n = 0}^{N - 1} {\sum }_{m = 0}^{PG - 1} {r}_{m , n} ( t ) {d}_{n} ( i ) c ( m ) {p}_{s} ( t - {iT}_{s} ) \\ cos \{ 2 π ( Nn + m ) Δ f ( t - {iT}_{s} ) \} + n ( t )\end{matrix} \qquad ( 4 )$$

where r_{m,n} is the received complex envelope at the (Nn+m)^{th} sub-carrier. The MC-CDMA receiver requires coherent detection for a successful despreading operation performed at a despreading module comprising PG multipliers 438 using a spread code with PG gains, a corresponding number of LPFs 440 and a summer 442 for each data symbol. After down-conversion, the m-th sub-carrier components (m=0, 1, . . . , PG−l) corresponding to the received data dₙ(i) are first coherently detected using FFT and then multiplied with the gain gₘ to combine the energy of the received signal 432 scattered in the frequency domain. Soft information generated at the output of the summer 442 is the sum of the weighted baseband components given by:

$$SI = {\sum }_{m = 0}^{PG - 1} {g}_{m} {r}_{m} \qquad ( 5 )$$

rₘ=hₘ(iTₛ)dₘcₘ+nₘ(iTₛ) (6)

where rₘ is the complex baseband component of the received signal 432 after down-conversion with sub-carrier frequency synchronization at the m-th sub-carrier, nₘ is the complex additive Gaussian noise at the m-th sub-carrier, and hₘ is the complex envelop of the m-th sub-carrier, hₘ is assumed to be a downlink channel.

The soft information of each packet is de-interleaved at a de-interleaver 443 by reordering the symbol sequence of each retransmission, preferably by using shifting or rotation or the like reordering operations, corresponding to the symbol sequence reordered for the same retransmission at the transmitter interleaver 413.

A packet combining module 444 then combines a current retransmitted packet with the previous erroneous packet stored in a buffer 446, preferably using Maximal Ratio Combining (MRC) technique. The gains for MRC are given by:

gₘ=cₘhₘ* (7)

MRC packet combining according to the Type I Hybrid ARQ method is used to combine a current retransmitted packet with the previous erroneous packet stored in a buffer 446. The details of MRC combining operation are described hereinafter.

The symbol sequence of a packet after the packet combining module 444 for a first transmission can be modelled as:

r₁=|h₁|·D+W₁ (8)

where |h₁| is the amplitude of the channel for the symbol, and W₁ is the Gaussian noise with zero mean and variance σ_{W}_{₁}. If a packet is detected to be erroneous, the packet is stored in the buffer 446. The symbol sequence of packet after the packet combining module 444 for a second transmission at the receiver can be modelled as:

r₂=|h₂|·D+W₂ (9)

where |h₂| is the amplitude of the channel for the retransmitted symbol, and W₂ is the corresponding Gaussian noise with zero mean and variance σ_{W}_{₂}. Thus, the combined symbol r_{SIC}_{_{—}}_{MC} can be written as:

$$r = \frac{\vert {h}_{1} \vert \cdot {r}_{1} + \vert {h}_{2} \vert \cdot {r}_{2}}{\sqrt{( {\vert {h}_{1} \vert}^{2} + {\vert {h}_{2} \vert}^{2} )}} \qquad ( 10 )$$

The reason for applying the MRC technique in the SLI method is that components of the symbol with large amplitudes are likely to contain relatively less noise. Thus, the effect of the components on the soft decision process is increased by squaring the amplitudes of the components.

If a symbol suffers deep fading during a previous transmission, it is possible for the same symbol during retransmission to be subject to a good frequency response after interleaving. There is thus a high probability of recovering the symbol after MRC packet combining.

After packet combining, the symbol sequence of a combined packet is provided to a FEC decoding block 448. A CRC-based check is performed at a CRC module 450 after FEC decoding. If the received packet is correct, an ACK signal 406 is sent back to the transmitter which then starts to transmit the next packet.

For purposes of providing a better understanding and appreciation of the underlying principles relating to the SLI method according to the first embodiment of the invention, a comparison between the conventional SPC method and the SLI method in relation to MC-CDMA systems is provided with reference to FIGS. 5a and 5b, respectively. Fundamentally an SPC-based system modulates a symbol on the same sub-carrier during different retransmissions, while an SLI-based system modulates a symbol on a different sub-carrier which experiences different fading for different retransmissions.

For example, as shown in FIG. 5a Symbol 1 suffers deep fading during a first transmission (S1T1) 502. During a second transmission for Symbol 1 (S1T2) 504, the SPC-based system modulates Symbol 1 to the same sub-carrier used during the first transmission S1T1 502. The sub-carrier typically may suffer deep fading, and this is more obvious when the sub-carrier is experiencing slow fading in the time domain. Therefore, four transmissions 502 to 508 are required for the combination of the energies of the four received variants of Symbol 1 (510 to 516) to recover Symbol 1 (518). On the other hand, as shown in FIG. 5b the SLI-based system modulates Symbol 1 on a different sub-carrier which typically may not suffer deep fading during a second transmission (S1T2) 534 after a first transmission (S1T1) 532 fails. Hence Symbol 1 538 can attain a higher energy level at the receiver during the second transmission. In such a case, a higher energy level for a combined packet 540 is achievable after the second transmission if the MRC technique is used for packet combining.

Therefore the SLI method enables an erroneous packet which suffers deep fade to 20 come out of the deep fade using fewer retransmissions. The advantage of SLI method over the conventional SPC method is more obvious when the fading is slower in the time domain.

In the conventional SPC-based MC-CDMA system, a modulated symbol is spread in the frequency domain before being modulated to a sub-carrier. However, in a multi-path fading channel signal variation occurs due to multi-path propagation, which often causes a transmitted signal to fall below the noise level thus resulting in a larger number of errors. As mentioned in the foregoing, it is less likely that all sub-carriers for MC-CDMA systems are located in a deep fade in the frequency domain. However, it is more likely that different sub-carriers having adjacent frequencies modulated by the same symbol are located in a deep fade in the frequency domain. Consequently, such a symbol would not be recoverable at the receiver. If however a different sequencing of the components of a packet is applied which allows different chips for the same symbol to not be located in a correlated channel in the frequency domain, the aforementioned problem may be alleviated. The CLI method is based upon such an analysis for MC-CDMA systems whereby a chip-level interleaver is inserted into a MC-CDMA system after spreading. As a result of the interleaving and de-interleaving operation, burst errors are spread out in frequency domain so that errors suffered by each sub-carrier modulated by one symbol appear independent. Thus, a burst error channel in the frequency domain is transformed into a random error channel at the input of the despreader and the decoder.

FIGS. 5c and 5d illustrate the underlying principle of the CLI method according to a second embodiment of the invention. As shown in FIG. 5c, an interleaver 558 inserted between a spreading module 554 and an IFFT block reorders the sequence of components of a packet after spreading to ensure that different sub-carriers modulated by the same symbol are located in an uncorrelated channel. Each component of the packet after spreading has a symbol sequence and is assigned a chip sequence, which in a conventional situation is modulated to an assigned sub-carrier in the IFFT block. However in the CLI method, the reordering of each component, for example by rotation or shifting or the like reordering operation, according to the symbol sequence and the chip sequence of the component, causes the modulation of the component to a sub-carrier other than the conventionally assigned sub-carrier thereby resulting in an averaging effect at symbol level. Essentially for one symbol, a sub-carrier subjected to good channel response helps to compensate for a sub-carrier subjected to poor channel response. The distribution of sub-carriers relating to one symbol in the frequency domain of the channel affects the averaging effect and subsequently influences the performance improvement.

Two interleaver patterns A and B are shown in FIGS. 5c and 5d, respectively. Pattern A is applied in the block interleaver 558 which helps to distribute chips into an uncorrelated channel to achieve diversity by reordering both the symbol and chip sequences for example by grouping the components with the same chip sequence. Such diversity can be achieved at initial transmission. The components of each group are then modulated to adjacent sub-carriers.

On the other hand, Pattern B is applied in a symbol-wise interleaver 568 that effectively assigns a certain symbol to several sub-carriers having adjacent frequencies that are subjected to good channel response during the retransmission by reordering only the symbol sequence for example by grouping the components with the same symbol sequence and reordering the groups of components during retransmissions. The components of each group are then modulated to adjacent sub-carriers. Diversity can only be achieved at the retransmission. The implementation of this pattern is equivalent to implementing the interleaver using the SLI method at the symbol level according to the first embodiment of the invention.

FIGS. 4c and 4d are block diagrams of a downlink transmitter and a downlink receiver, respectively, applying the CLI method in an MC-CDMA system according to the second embodiment of the invention. The MC-CDMA system preferably uses the Hybrid ARQ method with Turbo codes. In the transmitter shown in FIG. 4c, a data stream 452 is first stored in a Tx buffer 454, which is dependent on an ACK or NAK signal 456. The original data stream 452 is then processed by an FEC coding block 458 applying Turbo codes, and a modulation block 460. The modulated serial data stream is then converted to a parallel data stream with length N (d₀(i), d₁(i), . . . , d_{N}−1(i)) using a serial-to-parallel (S/P) converter 462.

A single symbol is replicated into PG parallel copies. Each symbol of the parallel data stream is multiplied by each chip of a spreading code of length PG at a spreader 462. The output of the spreader 464 is processed by an interleaver 465 according to Pattern A or Pattern B as illustrated in FIGS. 5c and 5d, respectively, or the like interleaver pattern which reorders the symbol sequence and chip sequence of the replicas of each symbol in the parallel data stream by performing block or symbol-wise or the like reordering operation on the chip sequence in the parallel data stream. For the first transmission of each packet, the symbol sequence and chip sequence of the interleaved parallel data stream is the same as the output of the spreader 464. For each subsequent different retransmission until the maximum number of retransmission, however, the symbol sequence and chip sequence of the interleaved parallel data stream is different.

Each replica of each symbol of the interleaved parallel data stream is then modulated to a sub-carrier spaced apart from neighboring sub-carriers by Δf at a modulator 466 and summed with all the sub-carriers at a summer 468, which collectively form an IFFT block 467. All the components of the replicated parallel data stream, a total of N=M×G (corresponding to the total number of sub-carriers) components, are hence modulated in baseband by the IFFT block 467 and a resulting transmitted signal 470 is outputted.

In a downlink channel, Walsh Hadamard codes are used as an optimum orthogonal sets, the complex equivalent lowpass transmitted signal is written as:

$$S ( t ) = {\sum }_{i = - ∞}^{+ ∞} {\sum }_{n = 0}^{N - 1} {\sum }_{m = 0}^{PG - 1} {( {d}_{n} ( i ) c ( m ) )}^{′} {p}_{s} ( t - {iT}_{s} ) cos \{ 2 π ( Nn + m ) Δ f ( t - {iT}_{s} ) \} \qquad ( 11 )$$

where c(m) is the spreading code with length PG, Tₛ is the symbol duration at sub-carrier, Δf is the minimum sub-carrier separation, (dₙ(i)c(m))′ denotes the interleaved signal after spreading.

In the MC-CDMA receiver shown in FIG. 4d, a received signal 482 passes through an FFT block 485, which consists of an S/P converter 484 and parallel detectors 486 using PG sub-carriers, after removing the Guard Interval (GI) from the received signal 482 with assumption of perfect synchronization. The N sub-carrier components corresponding to the received signal 482 are first coherently detected with FFT and subsequently the channel estimation is conducted based on the information from the pilot. The received signal is written as

$$r ( t ) = {\sum }_{i = - ∞}^{+ ∞} {\sum }_{n = 0}^{N - 1} {\sum }_{m = 0}^{PG - 1} {r}_{m , n} ( t ) {( {d}_{n} ( i ) c ( m ) )}^{′} {p}_{s} ( t - {iT}_{s} ) cos \{ 2 π ( Nn + m ) Δ f ( t - {iT}_{s} ) \} + n ( t ) \qquad ( 12 )$$

where r_{m,n} is the received complex envelope at the (Nₙ₊ₘ)^{th} sub-carrier.

After FFT operation, the chip-level signal is de-interleaved at a deinterleaver 487 using a corresponding deinterleaver pattern. The deinterleaved information sequence is despreaded at a despreading module 488 using the spread code {g(0), g(1), . . . , g(PG−1)} followed by processing by a demodulation block consisting of a bank of LPFs 490 and a summer 492.

The soft information at the output of the demodulation block is the sum of the weighted baseband components given by:

$$SI = {\sum }_{n = 0}^{PG - 1} {g}_{n} {{r}^{′}}_{n} \qquad ( 13 )$$

rₙ=hₙ(iTₛ)(dₙcₙ)′+nₙ(iTₛ) (14)

where rₙ and nₙ are the complex baseband components of the received signal after down-conversion with sub-carrier frequency synchronization and the complex additive Gaussian noise at the n-th sub-carrier, respectively, rₙ′ is the deinterleaved received signal, hₙ is the complex envelop of the n-th sub-carrier, hₘ is assumed to be a downlink channel.

Maximal Ratio Combining (MRC) technique is used in a packet combining module 494 to combine a current retransmitted packet with the previous erroneous packet stored in a buffer 496. The details of MRC packet combining are the same as the description for the foregoing SLI method.

A negative acknowledgement (NAK) is required to retransmit if the packet is failed. The increased received energy after combining results in an improvement in throughput of the system. If the packet is decoded correctly, the acknowledgement (ACK) is sent back to the transmitter, and next packet is transmitted.

The SLI and CLI methods according to embodiments of the invention have been extensively simulated for MC-CDMA systems with Turbo-codes. The results of a simulation obtained and disclosed hereinafter are based on simulation parameters described in Table I.

TABLE I
Simulation parameters for a broadband MC-CDMA system

| | |
|---|---|
| Bandwidth | 80 MHz |
| Number of sub-carrier, Nc | 512 |
| Spreading factor (SF) | 8 |
| Data modulation/Spreading | QPSK/QPSK |
| (Channelization/Scramble) | (Hadamard/Random) |
| Packet length per code | 1024 symbols |
| | (Data: 960, pilot: 64) |
| Pilot/Data symbol power ratio | 12 dB |
| Subcarrier combining scheme | EGC |
| Channel coding/decoding | Turbo coding (R = 2/3 K = 4)/ |
| | Max-Log-MAP decoding |
| Max iteration no of Turbo decoding | 8 |
| Max no of retransmission | 10 |
| Packet combining scheme | Chase combining |
| Round trip delay for ARQ | 6 packets |
| Channel model | Broadband Multipath fading |
| Maximum Doppler frequency | 5 Hz |

Transmitted signals are subjected to broadband channel propagation as shown in equation [1]. In this model, there are a total of 24 paths according to Rayleigh fading paths with an exponential decay power delay profile. The r.m.s. (root-mean-square) delay spread of 0.29 usec is used in the simulation.

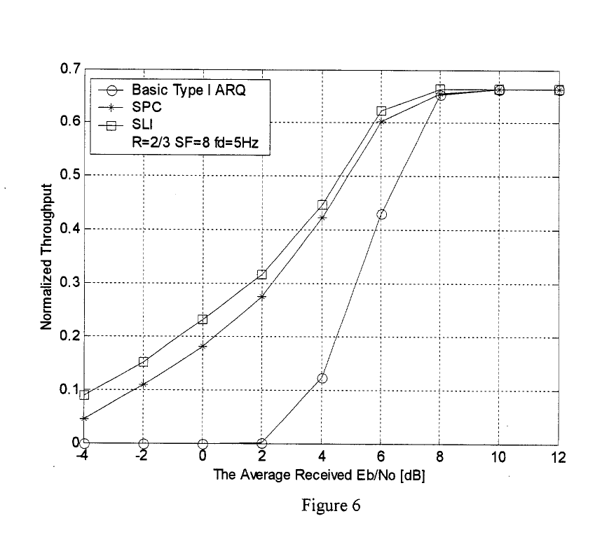

FIG. 6 shows the throughput comparison between the SPC and SLI methods for Turbo coded MC-CDMA systems, using the Basic Type I hybrid ARQ method as a reference. At a Maximum Doppler Frequency of fd=5 Hz, the SLI method provides a higher throughput than the SPC method and the Basic Type I hybrid ARQ method. When the average received Eb/No is lower, a larger improvement is achieved. This is because when the average received Eb/No becomes larger, the required number of retransmissions becomes less, and there is no chance for the SLI method to reorder the retransmissions. At a normalized throughput of 0.2/04/0.6, the SLI method can improve the average received Eb/No by approximately 1.5/0.5/0.25 dB and 5.25/2.5/1.8 dB compared to the SPC method and the Basic Type I hybrid ARQ method, respectively. The SLI provides a maximum throughput improvement of 94.5% over SPC when the average received Eb/No=−4 dB.

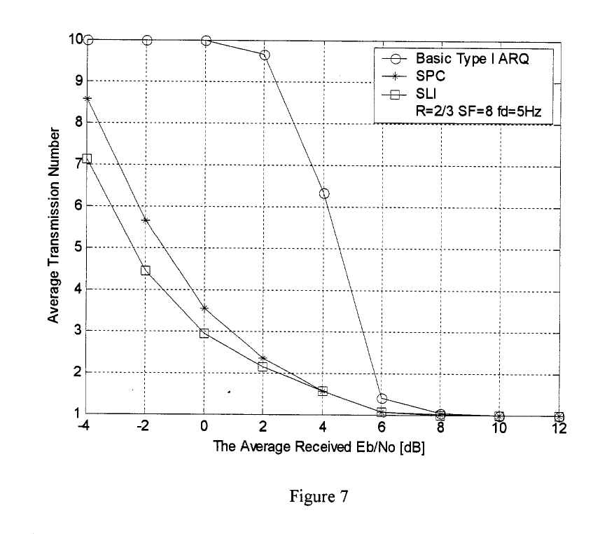

FIG. 7 shows the average number of transmissions for the SLI, SPC and Basic Type 1 Hybrid ARQ methods. The average number of transmissions for the SLI method is less than the average number of transmissions for the SPC method especially at a lower average received Eb/No. The reason is that when encountering deep fade, the SLI method uses fewer re-transmissions to recover an erroneous packet than the SPC method as the SLI method applies frequency diversity. The SLI method hence has a stronger ability to overcome deep fade. When the average received Eb/No reaches 10 dB, the average number of transmissions for the SLI, SPC and Basic Type I ARQ methods is 1. There is no re-transmission requirement anymore.

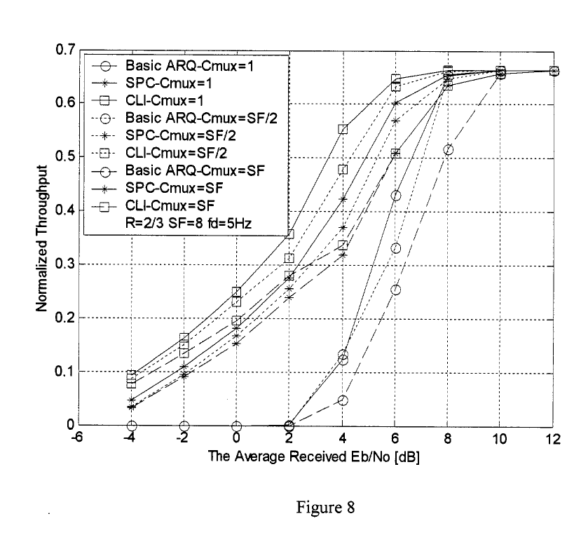

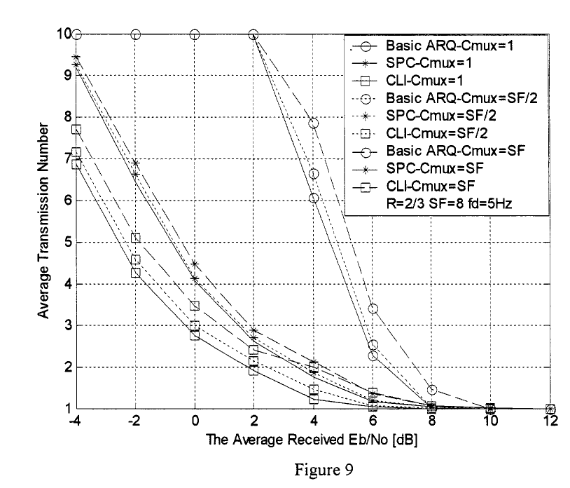

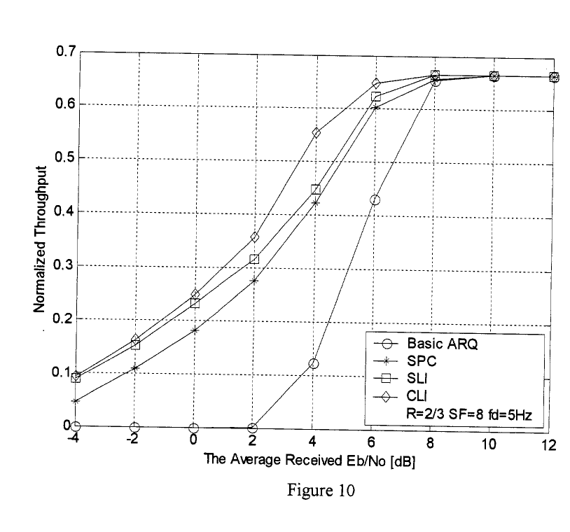

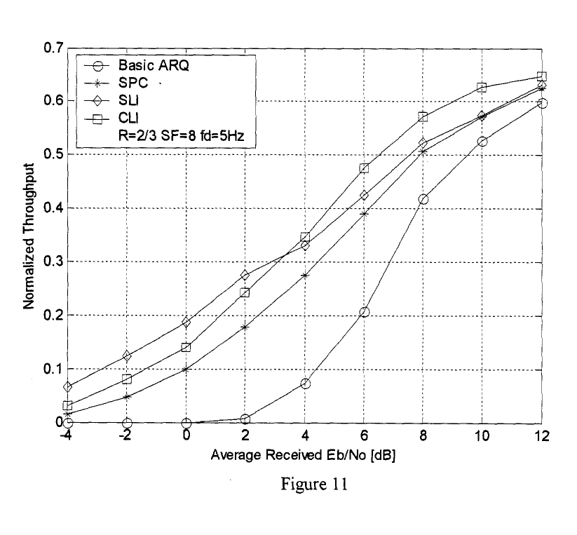

FIG. 8 shows the throughput comparison between the CLI and SPC methods for Turbo-coded MC-CDMA systems. FIG. 9 shows the average number of transmissions for the CLI, SPC and Basic Type I Hybrid ARQ methods. At a Maximum Doppler Frequency of fd=5 Hz, the CLI method provides higher throughput than the SPC and Basic Type I Hybrid ARQ methods in the case of one multiplexed code, half multiplexed code and full multiplexed code. The number of multiplexed code can be translated into a multi-code model or a multi-user mode. It is shown that the improvement of the CLI method over the SPC method does not follow the trend for the SLI method. With the increase of the average received Eb/No, the improvement is still there even when the average received Eb/No becomes larger. At a normalized throughput of 0.2/04/0.6, the CLI method can improve the average received Eb/No by approximately 1.5/1.4/1.0 dB and 5.25/3.4/2.55 dB compared to the SPC and Basic Type I Hybrid ARQ methods, respectively when the multiplexed code is one. It is also observed that the improvement is not reduced if more multiplexed code is used. In other words, the CLI method can also achieve the improvement in a multi-user environment. It is also observed that when the average transmission number becomes one at the average received Eb/No of 6 dB, the CLI method can still provide improvement over the SPC method. This is the different characteristic from the SLI method.

FIGS. 10 and 11 show the comparison between the CLI and SLI methods in different channel conditions. FIG. 10 shows the comparison in a channel with a large r.m.s delay spread and 24 multi-paths. It is observed that the CLI method provides better performance than the SLI method in all regions of the average received Eb/No. Especially, when the average received Eb/No becomes larger, the improvement of the CLI method over the SLI method becomes larger until the average received Eb/No reaches 6 dB. It is shown that in the medium and large Eb/No regions, the CLI method shows its advantage over the SLI method.

FIG. 11 shows the comparison between the CLI and SLI methods in a channel with a small r.m.s delay spread and 4 multi-paths. It is observed that the curve of the graph for the CLI method has a cross point with the curve of the graph for the SLI method. It is demonstrated that the SLI provides better throughput performance in lower Eb/No region whereas the CLI method provides larger improvement in higher Eb/No regions. A method to switch between the CLI and SLI methods for a MC-CDMA system based on the received Eb/No obtained from a feedback channel is therefore proposed herein as an alternate embodiment of the invention. When the average received Eb/No is lower than a threshold (such as 3 dB), a switch control signal is sent back to inform a transmitter to switch from the CLI method to the SLI method. When the received Eb/No is higher than the threshold, a signal is sent back to inform the transmitter to switch to the CLI method. Therefore in this case, an interleaver switcher can be used at the transmitter based on the switch control signal. Consequently, this switching method helps to improve the throughput performance in lower Eb/No region.

MC-CDMA systems provide for promising systems for future mobile communications and the SLI method is a powerful packet combining technique for such MC-CDMA systems. Packet transmission using the SLI or CLI method for MC-CDMA systems provides a simple and effective method to improve throughput of such systems. The SLI method can also be applied to Multi Carrier Modulation (MCM) systems, like OFDM systems or OFDM related applications. Therefore, there is much potential for the SLI or CLI methods to be introduced into 4G mobile communication systems.

In the foregoing manner, the interleave method for MC-CDMA is disclosed. Although only a number of embodiments are described, it will be apparent to one skilled in the art in view of this disclosure that numerous changes and/or modifications can be made without departing from the scope and spirit of the invention.

1. A method for providing retransmission signals using multi-carrier code division multiple access, the method comprising the steps of:
receiving a serial data stream in response to the failed prior reception of the serial data stream;
converting the serial data stream to a parallel data stream, the parallel data stream having a plurality of symbols having a symbol sequence;
performing spreading on the parallel data stream by spreading each of the plurality of symbols of the parallel data stream with a spreading code, the spreading code having a plurality of chips having a chip sequence;
performing multi-carrier modulation on the parallel data stream by modulating each of the plurality of symbols of the parallel data stream to a plurality of subcarriers and generating a plurality of modulated signals;
grouping the plurality of modulated signals for the plurality of symbols of the parallel data stream into a retransmission signal; and
reordering, prior to the modulation of the parallel data stream, the parallel data stream by reordering at least one of the symbol sequence of the plurality of symbols and the chip sequence of the plurality of chips.

2. The method as in claim 1, wherein the step of reordering the parallel data stream comprises the step of reordering the symbol sequence of the plurality of symbols of the parallel data stream prior to spreading the parallel data stream whereby diversity is achieved at retransmission.

3. The method as in claim 2, wherein the step of reordering the symbol sequence of the plurality of symbols comprises the step of shifting the plurality of symbols of the parallel data stream.

4. The method as in claim 1, wherein the step of reordering the parallel data stream comprises the step of reordering the chip sequence of the plurality of chips with which each of the plurality of symbols of the parallel data stream is spread prior to modulating the parallel data stream whereby diversity is achieved at initial transmission.

5. The method as in claim 4, wherein the step of reordering the chip sequence of the plurality of chips comprises the step of distributing the plurality of chips into an uncorrelated channel.

6. The method as in claim 1, further comprising the step of performing forward error correction prior to the step of converting the serial data stream to the parallel data stream.

7. The method as in claim 1, wherein the step of performing multi-carrier modulation comprises the step of modulating the plurality of subcarriers by a corresponding number of replicas of the each of the plurality of symbols of the parallel data stream wherein each of the plurality of subcarriers is spaced apart from an adjacent subcarrier by a frequency difference.

8. The method as in claim 7, further comprising the step of spreading the replicas of the each of the plurality of symbols with the plurality of chips of the spreading code for each of the replicas of the each of the plurality of symbols.

9. A method for retrieving data subsequent to the failed prior reception of a transmission signal transmitted using multi-carrier code division multiple access, the method comprising the steps of:
transmitting a failed reception signal in response to the failed prior reception of a transmission signal;
receiving a retransmission signal, the retransmission signal comprising a plurality of modulated signals for each of a plurality of symbols of a data stream in the retransmission signal, the data stream in the retransmission signal being reordered subsequent to the fail prior reception of the transmission signal;
retrieving the each of the plurality of symbols from the plurality of modulated signals;
reordering the data stream in the retransmission signal to the same order of a data stream in the transmission signal; and
performing packet combining of the reordered data stream in the retransmission signal.

10. The method as in claim 9, wherein the step of reordering the data stream in the retransmission signal comprises the step of reordering the symbol sequence of the plurality of symbols of the data stream in the retransmission signal to the same order of the data stream in the transmission signal.

11. The method as in claim 10, wherein the step of reordering the symbol sequence of the plurality of symbols comprises the step of shifting the plurality of symbols of the data stream.

12. The method as in claim 9, wherein the step of reordering the data stream in the retransmission signal comprises the step of reordering the chip sequence of a plurality of chips with which each of the plurality of symbols of the data stream is spread during retransmission.

13. The method as in claim 9, further comprising the step of storing the data stream in a buffer.

14. The method as in claim 13, wherein the step of performing packet combining of the reordered plurality of symbols and data stream comprises the step of performing packet combining of the reordered plurality of symbols and the data stream stored in the buffer.

15. The method as in claim 9, wherein the step of performing packet combining of the reordered plurality of symbols and data streams comprises the step of performing maximum ratio combining for combining the reordered plurality of symbols and data stream.

16. A system for providing retransmission signals using multi-carrier code division multiple access, the system comprising:
means for receiving a serial data stream in response to the failed prior reception of the serial data stream;
means for converting the serial data stream to a parallel data stream, the parallel data stream having a plurality of symbols having a symbol sequence;
means for performing spreading on the parallel data stream by spreading each of the plurality of symbols of the parallel data stream with a spreading code, the spreading code having a plurality of chips having a chip sequence;
means for performing multi-carrier modulation on the parallel data stream by modulating each of the plurality of symbols of the parallel data stream to a plurality of subcarriers and generating a plurality of modulated signals;
means for grouping the plurality of modulated signals for the plurality of symbols of the parallel data stream into a retransmission signal; and
means for reordering, prior to the modulation of the parallel data stream, the parallel data stream by reordering at least one of the symbol sequence of the plurality of symbols and the chip sequence of the plurality of chips.

17. The system as in claim 16, wherein the means for reordering the parallel data stream comprises means for reordering the symbol sequence of the plurality of symbols of the parallel data stream prior to spreading the parallel data stream.

18. The system as in claim 17, wherein the means for reordering the symbol sequence of the plurality of symbols comprises means for shifting the plurality of symbols of the parallel data stream.

19. The system as in claim 16, wherein the means for reordering the parallel data stream comprises means for reordering the chip sequence of the plurality of chips with which each of the plurality of symbols of the parallel data stream is spread prior to modulating the parallel data stream.

20. The system as in claim 19, wherein the means for reordering the chip sequence of the plurality of chips comprises means for distributing the plurality of chips into an uncorrelated channel.

21. The systems as in claim 16, further comprising means for performing forward error correction prior to converting the serial data stream to the parallel data stream.

22. The system as in claim 16, wherein the means for performing multi-carrier modulation comprises means for modulating the plurality of subcarriers by a corresponding number of replicas of the each of the plurality of symbols of the parallel data stream wherein each of the plurality of subcarriers is spaced apart from an adjacent subcarrier by a frequency difference.

23. The system as in claim 22, further comprising means for spreading the replicas of the each of the plurality of symbols with the plurality of chips of the spreading code for each of the replicas of the each of the plurality of symbols.

24. A system for retrieving data subsequent to the failed prior reception of a transmission signal transmitted using multi-carrier code division multiple access, the system comprising:
means for transmitting a failed reception signal in response to the failed prior reception of a transmission signal;
means for receiving a retransmission signal, the retransmission signal comprising a plurality of modulated signals for each of a plurality of symbols of a data stream in the retransmission signal, the data stream in the retransmission signal being reordered subsequent to the fail prior reception of the transmission signal;
means for retrieving the each of the plurality of symbols from the plurality of modulated signals;
means for reordering the data stream in the retransmission signal to the same order of a data stream in the transmission signal; and
means for performing packet combining of the reordered data stream in the retransmission signal.

25. The system as in claim 24, wherein the means for reordering the data stream in the retransmission signal comprises means for reordering the symbol sequence of the plurality of symbols of the data stream in the retransmission signal to the same order of the data stream in the transmission signal.

26. The system as in claim 25, wherein the means for reordering the symbol sequence of the plurality of symbols comprises means for shifting the plurality of symbols of the data stream.

27. The system as in claim 24, wherein the means for reordering the data stream in the retransmission signal comprises means for reordering the chip sequence of a plurality of chips with which each of the plurality of symbols of the data stream is spread during retransmission.

28. The system as in claim 24, further comprising means for storing the data stream in a buffer.

29. The system as in claim 28, wherein the means for performing packet combining of the reordered plurality of symbols and data stream comprises means for performing packet combining of the reordered plurality of symbols and the data stream stored in the buffer.

30. The system as in claim 24, wherein the means for performing packet combining of the reordered plurality of symbols and data streams comprises means for performing maximum ratio combining for combining the reordered plurality of symbols and data stream.
